(19) United States
(12) Patent Application Publication
(10) Pub. No.: US 2006/0014918 A1
(43) Pub. Date: Jan. 19, 2006

(54) COMPOSITIONS FOR USE IN GOLF BALLS

(75) Inventor: Murali Rajagopalan, South Dartmouth, MA (US)

Correspondence Address: ACUSHNET COMPANY, 333 BRIDGE STREET, P. O. BOX 965, FAIRHAVEN, MA, 02719, US

(73) Assignee: ACUSHNET COMPANY, Fairhaven, MA (US)

(21) Appl. No.: 11/162,552

(22) Filed: Sep. 14, 2005

Related U.S. Application Data
(63) Continuation-in-part of application No. 10/434,739, filed on May 9, 2003, now Pat. No. 6,949,617.
(63) Continuation-in-part of application No. 10/434,738, filed on May 9, 2003.
(63) Continuation-in-part of application No. 11/072,588, filed on Mar. 4, 2005.

(51) Int. Cl. C08G 18/10; C08G 18/48

(52) U.S. Cl. 528/61

(57) ABSTRACT

A golf ball having at least a core and a layer disposed about the core is disclosed. The layer is formed from a composition having multiple reactive and/or non-reactive ingredients. At least one of these ingredients is a polyether polyahl formed from three or more diols and/or cyclic ethers, such as oxolane, oxirane, and a chiral cyclic ether.

### CROSS-REFERENCE TO RELATED APPLICATIONS

This application is a continuation-in-part of U.S. application Ser. No. 10/434,739, filed May 9, 2003, now pending. This application is also a continuation-in-part of U.S. application Ser. No. 10/434,738, filed May 9, 2003, now pending. This application is further a continuation-in-part of U.S. application Ser. No. 11/072,588, filed Mar. 4, 2005, now pending. Disclosures of these applications are incorporated herein by reference in their entirety.

### FIELD AND BACKGROUND

The present disclosure is directed to compositions for use in golf ball that incorporate polymerized polyahls formed from different diols and/or cyclic ethers, and golf balls formed from such compositions. One conventional material used to form golf ball covers is balata, a natural or synthetic trans-polyisoprene rubber. The softness of the balata cover allows the player to achieve spin rates sufficient to more precisely control ball direction and distance, particularly on shorter shots. However, balata covers lack the durability required by the average golfer, and are easily damaged. Accordingly, alternative cover compositions have been developed in an attempt to provide balls with spin rates and a feel approaching those of balata covered balls, while also providing a golf ball with a higher durability and overall distance.

Ionomer resins (e.g., copolymers of olefin, such as ethylene, and ethylenically unsaturated carboxylic acids, such as (meth)acrylic acids, wherein the acid groups are partially or fully neutralized by metal ions) have also been used as golf ball cover materials. Ionomer covers may be virtually cut-proof, but in comparison to balata covers, they display inferior spin and feel properties.

Polyurethanes and polyureas, by providing soft “feel,” have also been recognized as useful materials for golf ball covers. However, conventional polyurethane covers do not match ionomer covers with respect to resilience or rebound. Unsaturated components (such as aromatic diisocyanate, aromatic polyol, and/or aromatic polyamine) used in a polyurethane or polyurea composition may at least in part attribute to the composition's susceptibility to discoloration and degradation upon exposure to thermal and actinic radiation, such as ultraviolet (UV) light. Conventional polyurethane covers can be prone to absorption of moisture, which is another mechanism through which desirable physical properties in the cover may be compromised. Moisture passed through the cover may further deteriorate physical and performance properties of the core.

Therefore, a continuing need remains for novel material compositions usable in forming golf ball portions (e.g., covers) having desirable and/or optimal combination of physical and performance characteristics. Compositions disclosed herein provide certain desirable properties suitable for forming one or more portions of the golf ball.

### SUMMARY

This disclosure is directed to a golf ball having a core and at least one layer (e.g., cover layer) disposed about the core. Optionally, the golf ball further comprises an outer cover layer disposed about the at least one layer, or an intermediate layer disposed between the core and the at least one layer. The core may have a diameter of 1 inch or greater. The at least one layer may have a thickness of 0.005 inches to 0.1 inches. The core may be a solid core having a compression of 40 to 100 and/or a coefficient of restitution of 0.7 or greater. The at least one layer may have a flexural modulus of 1,000 psi to 100,000 psi or a Shore D hardness of 90 or less. The golf ball may have a coefficient of restitution of 0.7 or greater.

The at least one layer may be formed from a composition comprising a polyether polyahl. In one example, the composition may further comprise a polyisocyanate reactive to the polyether polyahl to form an isocyanate-containing prepolymer. In another example, the composition may further comprise an isocyanate-containing prepolymer formed from a telechelic polyahl and a polyisocyanate, and the prepolymer is reactive to the polyether polyahl. In a further example, the polyether polyahl comprises three or more different oxyalkylene monomer units that are independently substituted or unsubstituted. In a further example, the polyether polyahl is formed from three or more different cyclic ethers, at least one of which is chosen from halogen-substituted cyclic ethers, and ethers, esters, urethanes, or ureas of hydroxyl- or amine-substituted cyclic ethers. In a further example, the polyether polyahl comprises —O(CH2)₄—, —O(CH2)₂—, and a branched oxyalkylene monomer unit.

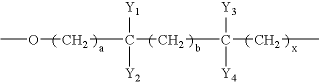

In forming the polyether polyahl, the branched oxyalkylene monomer unit may have a structure above, where Y₁ to Y₄ are independently hydrogen or hydrocarbon moieties, at least one of which is an alkyl moiety having 1 to about 10 carbon atoms; and a, b, and x are independently zero or integers from 1 to about 10. In one example, the branched oxyalkylene monomer unit is —OCH₂CH(CH₃)(CH₂)₂—, —OCH(CH₃)(CH₂)₃—, —OCH(CH₃)(CH₂)₂—, —OCH₂CH(CH₃)CH₂—, —OC(CH₃)₂CH₂—, —OCH(C₂H₅)CH₂—, or —OCH(CH₃)CH₂—. In another example, the polyether polyahl may be formed from oxolane having a molar fraction M₁ of 0.01 to 0.9, oxirane having a molar fraction M₂ of 0.005 to 0.6, a chiral cyclic ether having a molar fraction M₃ of 0.005 to 0.8, and M₁+M₂+M₃≦1.

In one example, the polyether polyahl has a random or block copolyether backbone and primary or secondary hydroxyl or amine end groups. In another example, the polyether polyahl is an α,β-dihydroxytelechelic copolyether, an α,β-diaminotelechelic copolyether, or an α-amino-β-hydroxytelechelic copolyether. In a further example, the composition forms an addition reaction product, preferably being a polyurethane or polyurea having a soft segment formed from the polyether polyahl. In a further example, the polyether polyahl is free of unsaturated aliphatic hydrocarbon radicals and aromatic hydrocarbon radicals. In a further example, the polyether polyahl is substantially saturated. In a further example, the polyether polyahl has a random or block copolyether backbone, and a structure of Z₁-(OR₇)ᵣ—(OR₈)ₛ—(OR₉)ₜ-Z₂, where R₇, R₈, and R₉ are different divalent radicals chosen from unsubstituted and substituted C₂₋₂₀ linear or branched alkylenes; Z₁ and Z₂ are the same or different monovalent radicals each comprising one or more active hydrogen moieties; r, s, and t are independent numbers each being 0.005 to 0.99, and r+s+t=1. Preferably, each of Z₁ and Z₂ independently comprises a primary hydroxyl group or a primary or secondary amine group. Further preferably, R₇ is —(CH₂)₄—, R₈ is —(CH₂)₂—, and R₉ is —CH(CH₃)(CH₂)₃—, —CH₂CH(CH₃)CH₂CH₂—, —CH(C₂H₅)(CH₂)₃—, —CH₂CH(C₂H₅)CH₂CH₂—, —(CH₂)₃—, —(CH₂)₅—, —(CH₂)₆—, —(CH₂)₇—, —(CH₂)₈—, or —(CH₂)₉—.

Definitions

Any numeric references to amounts, unless otherwise specified, are “by weight.” The term “equivalent weight” is a calculated value based on the relative amounts of the various ingredients used in making the specified material and is based on the solids of the specified material. The relative amounts are those that result in the theoretical weight in grams of the material, like a polymer, produced from the ingredients and give a theoretical number of the particular functional group that is present in the resulting polymer.

Other than in the operating examples, or unless otherwise expressly specified, all of the numerical ranges, amounts, values and percentages such as those for amounts of materials, times and temperatures of reaction, ratios of amounts, values for molecular weight (whether number average molecular weight (“Mₙ”) or weight average molecular weight (“M_{w}”), and others in the following portion of the specification may be read as if prefaced by the word “about” even though the term “about” may not expressly appear with the value, amount or range. Accordingly, unless indicated to the contrary, the numerical parameters set forth in the following specification and attached claims are approximations that may vary depending upon the desired properties sought to be obtained by the present disclosure. At the very least, and not as an attempt to limit the application of the doctrine of equivalents to the scope of the claims, each numerical parameter should at least be construed in light of the number of reported significant digits and by applying ordinary rounding techniques.

Notwithstanding that the numerical ranges and parameters setting forth the broad scope of the disclosure are approximations, the numerical values set forth in the specific examples are reported as precisely as possible. Any numerical value, however, inherently contain certain errors necessarily resulting from the standard deviation found in their respective testing measurements. Furthermore, when numerical ranges of varying scope are set forth herein, it is contemplated that any combination of these values inclusive of the recited values may be used.

For molecular weights, whether Mₙ or M_{w}, these quantities are determined by gel permeation chromatography using polystyrene as standards as is well known to those skilled in the art and such as is discussed in U.S. Pat. No. 4,739,019 at column 4, lines 2-45, which is incorporated herein by reference in its entirety.

As used herein, the term “polyahl” or “reactive polyahl” refers to any one compound or a mixture of compounds containing a plurality of active hydrogen moieties per molecule. Illustrative of such active hydrogen moieties are —OH (hydroxy group), —SH (thio group), —COOH (carboxylic acid group), and —NHR (amine group), with R being hydrogen, alkyl, aryl, or epoxy; all of which may be primary or secondary. These active hydrogen moieties are reactive to free isocyanate groups, forming urethane, urea, thiourea or corresponding linkage depending on the particular active hydrogen moiety being reacted. The polyahls may be monomers, homo-oligomers, co-oligomers, homopolymers, or copolymers. Oligomeric and polymeric polyahls having at least one NCO-reactive group on each terminal of a backbone are typically employed as the soft segment in reaction products such as polyureas and polyurethanes. Depending on the terminal groups, the oligomeric and polymeric polyahls may be identified as polyols (with —OH terminals only), polyamines (with —NHR terminals only), or amino alcohol oligomers or polymers (with both —OH and —NHR terminals). Such polyahls with a relatively low molecular weight (less than about 5,000), and a wide variety of monomeric polyahls, may be used as curing agents. The polyahls may be liquids at ambient temperatures or solids meltable at relatively low temperatures.

As used herein the term “chiral” is used on materials having a molecular structure that is not superimposible on its mirror image. Some chiral molecules have one or more chiral centers, in which an atom such as carbon is bonded to four different moieties. Other chiral molecules may not have any such chiral centers. Any one chiral molecule disclosed herein includes all of its stereoisomers and optical isomers, such as (R) and (S) enantiomers and diastereomers, and mixture thereof, such as racemic mixtures (i.e., exact 50:50 mixtures of opposite enantiomers).

As used herein, the terms “polydispersity” and “dispersity” refer to the ratio of M_{w} to Mₙ, an indicator of the degree of molecular weight distribution of a polymer and the extent to which the polymer chains share the same degree of polymerization. Polydispersity has a theoretical minimum of 1.0.

As used herein, the term “polymer” refers to oligomers, adducts, homopolymers, random copolymers, pseudo-copolymers, statistical copolymers, alternating copolymers, periodic copolymer, bipolymers, terpolymers, quaterpolymers, other forms of copolymers, substituted derivatives thereof, and combinations of two or more thereof. These polymers can be linear, branched, block, graft, monodisperse, polydisperse, regular, irregular, tactic, isotactic, syndiotactic, stereoregular, atactic, stereoblock, single-strand, double-strand, star, comb, dendritic, and/or ionomeric.

The subscript letters such as m, n, x, y, and z used herein within the generic structures of polymers, unless specified otherwise, are understood by one of ordinary skill in the art as the degree of polymerization (i.e., the number of consecutively repeating units). In the case of molecularly uniform products, these numbers are commonly integers, if not zero. In the case of molecularly non-uniform products, these numbers are averaged numbers not limited to integers, if not zero, and are understood to be the average degree of polymerization.

As used herein, the terms “telechelic” and “telechelic polymer” refer to polymers having at least two terminal reactive end-groups and capable of entering into further polymerization through these reactive end-groups. Reactive end-groups disclosed herein include, without limitation, amine groups, hydroxyl groups, isocyanate groups, carboxylic acid groups, thiol groups, and combinations thereof.

As used herein, the term “saturated” or “substantially saturated” means that the compound or material of interest is fully saturated (i.e., contains no double bonds, triple bonds, or aromatic ring structures), or that the extent of unsaturation is negligible, e.g. as shown by a bromine number in accordance with ASTM E234-98 of less than 10, or less than 5.

As referred to herein, lower alkyls and lower alkoxies include C₁₋₅, preferably C₁₋₃, alkyls and alkoxies. Non-limiting examples include methyl, ethyl, n-propyl, isopropyl, n-butyl, isobutyl, sec-butyl, t-butyl, amyl, isoamyl, methoxy, ethoxy, isopropoxy, isobutoxy, and t-butoxy.

As referred to herein, halogens include fluorine, chlorine, bromine, and iodine.

As referred to herein, linear or branched alkyls include C₁₋₃₀, preferably C₁₋₂₀, more preferably C₁₋₁₂, and most preferably C₁₋₈ alkyls, such as C₁₋₅ lower alkyls and C₆₋₃₀ higher alkyls. Non-limiting examples include methyl, ethyl, n-propyl, isopropyl, n-butyl, sec-butyl, t-butyl, amyl, isoamyl, n-hexyl, 2-ethyl-n-hexyl, n-heptyl, n-octyl, isooctyl, n-nonyl, isononyl, and n-dodecyl.

As referred to herein, substituted radicals include carbon-based radicals in which one or more carbon-bound hydrogen atom(s) is/are replaced by substituents and groups such as, without limitation, halogens, hydroxyl groups, amine groups, cyano groups, alkyl groups, alkoxy groups, thiol groups, thioether groups, nitro groups, and isocyanate groups. For example, non-limiting examples of substituted alkyls include cyanoalkyl, haloalkyl, hydroxyalkyl, alkoxyalkyl, preferably C₂₋₆ substituted alkyls, e.g., β-cyanoethyl, β-chloroethyl, β-hydroxyethyl, β-methoxyethyl, and β-ethoxyethyl.

As used herein, the terms “formed from” and “formed of” denote open, e.g., “comprising,” claim language. As such, it is intended that a composition “formed from” or “formed of” a list of recited components be a composition comprising at least these recited components, and can further comprise other non-recited components during formulation of the composition.

As used herein, the term “cure” as used in connection with a composition, e.g., “a curable material,” “a cured composition,” shall mean that any crosslinkable components of the composition are at least partially crosslinked. In certain examples of the present disclosure, the degree of crosslinking can range from 5% to 100% of complete crosslinking. In other examples, the degree of crosslinking can range from 35% to 85% of full crosslinking. In other examples, the degree of crosslinking can range from 50% to 85% of full crosslinking. One skilled in the art will understand that the presence and degree of crosslinking can be determined by a variety of methods, such as dynamic mechanical thermal analysis (DMTA) in accordance with ASTM E1640-99.

As used herein, the term “percent NCO” or “% NCO” refers to the percent by weight of free, reactive, and unreacted isocyanate functional groups in an isocyanate-functional molecule or material. The total formula weight of all the NCO groups in the molecule or material, divided by its total molecular weight, and multiplied by 100, equals the percent NCO.

As used herein, the term “equivalent” is defined as the number of moles of a functional group in a given quantity of material, and calculated from material weight divided by equivalent weight, the later of which refers to molecular weight per functional group. For isocyanates the equivalent weight is (4210 grams)/% NCO; and for polyols, (56100 grams)/OH#.

As used herein, the term “flexural modulus” or “modulus” refers to the ratio of stress to strain within the elastic limit (measured in flexural mode) of a material, indicates the bending stiffness of the material, and is similar to tensile modulus. Flexural modulus, typically reported in Pa or psi, is derived in accordance to ASTM D6272-02.

As used herein, the term “water vapor transmission rate” (“WVTR”) refers to the mass of water vapor that diffuses into a material of a given thickness (e.g., 1 mm) per unit area (e.g., 1 m²) per unit time (e.g., 24 h) at a specific temperature (e.g., 38° C.) and humidity differential (e.g., 90% relative humidity). Standard test methods for WVTR include ASTM E96-00, method E, ASTM D1653-03, and ASTM F1249-01.

As used herein, the term “material hardness” refers to indentation hardness of non-metallic materials in the form of a flat slab or button as measured with a durometer. The durometer has a spring-loaded indentor that applies an indentation load to the slab, thus sensing its hardness. The material hardness can indirectly reflect upon other material properties, such as tensile modulus, resilience, plasticity, compression resistance, and elasticity. Standard tests for material hardness include ASTM D2240-02b. Unless otherwise specified, material hardness reported herein is in Shore D. Material hardness is distinct from the hardness of a golf ball portion as measured directly on the golf ball (or other spherical surface). The difference in value is primarily due to the construction, size, thickness, and material composition of the golf ball components (i.e., center, core and/or layers) that underlie the portion of interest. One of ordinary skill in the art would understand that the material hardness and the hardness as measured on the ball are not correlated or convertible.

As used therein, the term “compression,” also known as “Atti compression” or “PGA compression,” refers to points derived from a Compression Tester (ATTI Engineering Company, Union City, N.J.), a scale well known in the art for determining relative compression of a spherical object. Atti compression is approximately related to Riehle compression: Atti compression≈(160-Riehle compression). Compression is a property of a material as measured on a golf ball construction (i.e., on-ball property), not a property of the material per se.

As used herein, the term “coefficient of restitution” or “CoR” for golf balls or subassemblies thereof is defined as the ratio of a ball's rebound velocity to its initial incoming velocity when the ball is fired out of an air cannon into a stationary, steel plate which provides an impact surface weighing about 100 pounds or about 45 kilograms. The time periods, Tᵢₙ and Tₒᵤₜ, of the ball flight between two separate ballistic light screens placed between the air cannon and the plate are measured to calculate CoR=Tₒᵤₜ/Tᵢₙ. The faster a golf ball rebounds, the higher the CoR it has, the more the total energy it retains when struck with a club, and the longer the ball flies. The reported CoR's initial velocity is about 50 ft/s to about 200 ft/s, and is usually understood to be 125 ft/s, unless otherwise specified. A golf ball may have different CoR values at different initial velocities.

As referred to herein, “Mooney” viscosity is a unit used to measure the plasticity of raw or unvulcanized rubber. The plasticity in a Mooney unit is equal to the torque, measured on an arbitrary scale, on a disk in a vessel that contains rubber at a temperature of 100° C. and rotates at two revolutions per minute. The measurement of Mooney viscosity is defined according to ASTM D-1646.

As used herein and to conventional practice, the units “phr” and “phw” refer to parts by weight of a respective material per 100 parts by weight of the base polymer or polymer blend.

### DETAILED DESCRIPTION

The compositions of the present disclosure may be used in any portion of the golf ball, preferably in the cover or in one or more optional intermediate layers disposed between the core and the cover. The cover may have a single-layer construction, or a multi-layer construction that includes one or more inner cover layers and an outer cover layer. The optional intermediate layer may have a single-layer construction, or a multi-layer construction that includes two or more discrete, preferably adjoining, layers.

As such, a portion of the golf ball of the present disclosure (e.g., a single-layer cover, an outer cover layer, an inner cover layer, an intermediate cover layer, an intermediate layer) may comprise about 1 weight percent to about 100 weight percent, preferably about 5 weight percent to about 95 weight percent, of a thermoplastic or thermoset composition. The composition, preferably formed from a castable liquid reactive material or a reaction injection moldable (“RIM”) material, comprises at least one polyether polyahl (polyol, polyamine, or aminoalcohol) having three or more different oxyalkylene (independently substituted or unsubstituted) monomer units. The polyether polyahl may be free of unsaturated aliphatic hydrocarbon radicals. The polyether polyahl may be free of aromatic hydrocarbon radicals. Preferably, the polyether polyahl is substantially saturated. Such polyether polyahls may be a polymerization product of three or more different diols and/or cyclic ethers, which may independently be chiral and/or achiral. The different diols, cyclic ethers, and monomer units (e.g., oxyalkylene) may be alkyl substituted, (per)haloalkyl substituted, or unsubstituted. Such polyether polyahls may have a random or block copolyether backbone.

In one example, at least one (i.e., one, two, or more) of the oxyalkylene monomer units is branched, having a structure of:

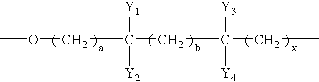

In the above structure, Y₁ to Y₄ are independently hydrogen or hydrocarbon (substituted or unsubstituted), preferably alkyl (substituted or unsubstituted), moieties, at least one of which is an alkyl (substituted or unsubstituted) moiety having 1 to about 10 carbon atoms; and a, b, and x are independently zero or integers from 1 to about 10, but a+b+x≧1. Preferably, Y₁ to Y₄ all have less than about 6 carbon atoms, and a, b, and x are all less than about 6. The branched oxyalkylene monomer units may be co-present with two or more linear oxyalkylene (substituted or unsubstituted) monomer units, each having 2 to about 20 carbon atoms. Non-limiting examples of suitable oxyalkylene monomer units include those having the structure of —OA- where A can be any of the alkylene structures described herein below.

A non-limiting generic structure of suitable random or block copolyether polyahls is Z₁-(OR₇)ᵣ—(OR₈)ₛ—(OR₉)ₜ-Z₂, where R₇, R₈, and R₉ are different divalent radicals chosen from unsubstituted and substituted (e.g., (per)halogenated) C₂₋₂₀ linear or branched alkylenes; Z₁ and Z₂ are the same or different monovalent radicals each comprising one or more active hydrogen moieties (e.g., Z₁ may be H, Z₂ may be OH or NHR); r, s, and t, representing degree of polymerization, are numbers each being 0.005 or greater and 0.99 or less, preferably 0.01 to 0.95, more preferably 0.03 to 0.9, most preferably 0.05 to 0.85, and r+s+t=1. It is understood by one skilled in the art that the monomer units OR₇—, —OR₈—, and —OR₉— may be distributed randomly along the backbone or in blocks of repeating units. Non-limiting examples of R₇, R₈, and R₉ include nonsubstituted linear or branched alkylenes —(CH₂)₂—, —(CH₂)₃—, —(CH₂)₄—, —(CH₂)₅—, —(CH₂)₆—, —(CH₂)₇—, —(CH₂)₈—, —(CH₂)₉—, —CH(CH₃)CH₂—, —C(CH₃)₂CH₂—, —CH(CH₃)CH(CH₃)—, —CH(C₂H₅)CH₂—, —CH(CH₃)CH₂CH₂—, —CH₂CH(CH₃)CH₂—, —CH₂C(CH₃)₂CH₂—, —CH(CH₃)(CH₂)₃—, —CH₂CH(CH₃)CH₂CH₂—, —CH(C₂H₅)(CH₂)₃—, —CH₂CH(C₂H₅)CH₂CH₂—, —C(CH₃)₂(CH₂)₃—, —CH₂C(CH₃)₂(CH₂)₂—, —CH₂CH(CH₃)CH(CH₃)CH₂—, —CH(CH₃)CH₂CH₂CH(CH₃)—, —CH(CH₃)(CH₂)₄—, —CH₂CH(CH₃)(CH₂)₃—, —(CH₂)₂CH(CH₃)(CH₂)₂—, and substituted linear or branched alkylenes —CH(CH₂F)CH₂—, —CH(CH₂Cl)CH₂—, —CH(CH₂Br)CH₂—, —CF(CF₃)CF₂—, —CH(CH₂C₂F₅)CH₂—, —CH(CH₂C₃F₇)CH₂—, —CH(CH₂C₄F₉)CH₂—, —CH(CH₂C₅F₁₁)CH₂—, —CH(CH₂C₆F₁₃)CH₂—, —CH(CH₂C₇F₁₅)CH₂—, —CH(CH₂C₈F₁₇)CH₂—, —CH(CH₂C₉F₁₉)CH₂—, —CH(CH₂C₁₀F₂₁)CH₂—, —CH(CH₂C₁₁F₂₃)CH₂—.

Each of Z₁ and Z₂ may independently comprise a C₁₋₂₀ radical covalently bonded to the one or more active hydrogen moieties, and optionally further comprise one, two, or more heteroatoms (e.g., O, N, S, Si, P). The value of s may be 0.01 to 0.6, preferably 0.01 to 0.3, more preferably 0.03 to 0.5, most preferably 0.08 to 0.25. The value of t may be 0.01 to 0.8, preferably 0.01 to 0.5, more preferably 0.01 to 0.2, further preferably 0.05 to 0.25, most preferably 0.05 to 0.15. The value of r may be equal to 1−s−t or, when one or more other monomer units are present, less than 1−s−t, and preferably 0.15 or greater, but not more than 0.9, more preferably 0.2 to 0.8, most preferably 0.25 to 0.5. Typically, r is greater than or equal to s and t, while s may be greater than or equal to t, but preferably less than t. In one example, the polyether backbone of the polyether polyahl comprises a first oxyalkylene (substituted or unsubstituted) monomer unit that is linear (e.g., R₇ is —(CH₂)₄—), a second monomer unit that is linear or branched (e.g., R₈ is —(CH₂)₂—), and a third oxyalkylene monomer unit that is linear or branched (e.g., R₉ is —CH(CH₃)(CH₂)₃—, —CH₂CH(CH₃)CH₂CH₂—, —CH(C₂H₅)(CH₂)₃—, —CH₂CH(C₂H₅)CH₂CH₂—, —(CH₂)₃—, —(CH₂)₅—, —(CH₂)₆—, —(CH₂)₇—, —(CH₂)₈—, or —(CH₂)₉—). In another example, the polyether backbone of the polyether polyahl comprises three different branched oxyalkylene (substituted or unsubstituted) monomer units. In a further example, the polyether backbone of the polyether polyahl comprises one, two, three, or more halogen-substituted linear or branched oxyalkylene monomer units.

The polyether polyahl described above may be an α,β-dihydroxytelechelic copolyether (e.g., Z₁ and Z₂ each having one primary or secondary hydroxyl group), an α,β-diaminotelechelic copolyether (e.g., Z₁ and Z₂ each having one primary or secondary amine group), or an α-amino-β-hydroxytelechelic copolyether (e.g., one of Z₁ and Z₂ having a primary or secondary hydroxyl group, and the other having one primary or secondary amine group). The polyether backbone may be formed from a combination of different diol monomers and/or cyclic ether monomers, which may independently be chiral or achiral.

Chiral diols suitable for forming the polyether polyahls preferably have a generic structure of:

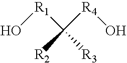

In the above structure, R₁ and R₄ are different linear or branched hydrocarbon, preferably alkylene, moieties having 1 to about 10 carbon atoms, R₂ and R₃ are different moieties selected from hydrogen and linear or branched hydrocarbon, preferably alkyl, moieties having 1 to about 10 carbon atoms. More preferably, R₁ and R₄ are alkylene moieties having 1 to about 6 carbon atoms, while at least one of R₂ and R₃ is an alkyl moiety having 1 to about 6 carbon atoms. Other non-limiting chiral and achiral diols include those having one, two, or more heteroatoms (e.g., O, N, S, P, Si) in the main chain, and those wherein one or more carbon atoms are independently substituted with two of the same or different radicals chosen from H, C₁₋₁₀ alkyls, halogens, and C₁₋₁₀ (per)haloalkyls. Non-limiting examples of chiral and achiral diols include HO(CH₂)₂OH, HO(CH₂)₃OH, HO(CH₂)₄OH, HO(CH₂)₅OH, HO(CH₂)₆OH, HO(CH₂)₇OH, HO(CH₂)₈OH, HO(CH₂)₉OH, HOCH(CH₃)CH₂OH, HOC(CH₃)₂CH₂OH, HOCH(CH₃)CH(CH₃)OH, HOCH(C₂H₅)CH₂OH, HOCH(CH₃)CH₂CH₂OH, HOCH₂CH(CH₃)CH₂OH, HOCH₂C(CH₃)₂CH₂OH, HOCH(CH₃)(CH₂)₃OH, HOCH₂CH(CH₃)CH₂CH₂OH, HOCH(C₂H₅)(CH₂)₃OH, HOCH₂CH(C₂H₅)CH₂CH₂OH, HOC(CH₃)₂(CH₂)₃OH, HOCH₂C(CH₃)₂(CH₂)₂OH, HOCH₂CH(CH₃)CH(CH₃)CH₂OH, HOCH(CH₃)CH₂CH₂CH(CH₃)OH, HOCH(CH₃)(CH₂)₄OH, HOCH₂CH(CH₃)(CH₂)₃OH, HO(CH₂)₂CH(CH₃)(CH₂)₂OH, HOCH(CH₂F)CH₂OH, HOCH(CH₂Cl)CH₂OH, HOCH(CH₂Br)CH₂OH, HOCF(CF₃)CF₂OH, HOCH(CH₂C₂F₅)CH₂OH, HOCH(CH₂C₃F₇)CH₂OH, HOCH(CH₂C₄F₉)CH₂OH, HOCH(CH₂C₅F₁₁)CH₂OH, HOCH(CH₂C₆F₁ 3)CH₂OH, HOCH(CH₂C₇F₁ 5)CH₂OH, HOCH(CH₂C₈F₁ 7)CH₂OH, HOCH(CH₂C₉F₁₉)CH₂OH, HOCH(CH₂C₁₀F₂₁)CH₂OH, HOCH(CH₂C₁₁F₂₃)CH₂OH.

Chiral cyclic ethers suitable for forming the polyether polyahls preferably have a generic structure of:

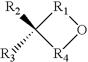

In the above strucuture, R₁ and R₄ are different linear or branched hydrocarbon, preferably alkylene, moieties having 1 to about 10 carbon atoms, R₂ and R₃ are different moieties selected from hydrogen or linear or branched hydrocarbon, preferably alkyl, moieties having 1 to about 10 carbon atoms. More preferably, R₁ and R₄ are alkylene moieties having 1 to about 6 carbon atoms, while at least one of R₂ and R₃ is an alkyl moiety having 1 to about 6 carbon atoms. Other non-limiting chiral and achiral cyclic ethers include cyclic polyethers having two, three, or more O atoms in the ring (e.g., 1,2-dioxirane, 1,2-dioxetane, 1,3-dioxetane, 1,2-dioxolane, 1,3-dioxolane, 1,2,3-trioxolane, 1,2,4-trioxolane, 1,2-dioxane, 1,3-dioxane, 1,4-dioxane, 1,3,5-trioxane, 1,3,5,7-tetraoxocane, and other crown polyethers like 1,3,5,7,9-pentoxecane) and those wherein one or more carbon atoms are independently substituted with two of the same or different radicals chosen from H, C₁₋₁₀ alkyls, halogens, and C₁₋₁₀ (per)haloalkyls, such as methyl, ethyl, propyl, isopropyl, butyl, sec-butyl, t-butyl, pentyl, hexyl, heptyl, octyl, nonyl, decyl, chlorine, bromine, iodine, fluoromethyl, di- and tri-fluoromethyls, chloromethyl, di- and tri-chloromethyls, bromomethyl, iodomethyl, 2-chloroethyl, 3-chloropropyl, 3,3,3-tribromopropyl, perfluoroalkyls, perchloroalkyls, perbromoalkyls, and the like.

Non-limiting examples of chiral and achiral cyclic ethers include oxirane, methyloxirane, ethyloxirane, propyloxirane, n-butyloxirane, t-butyloxirane, pentyloxirane, hexyloxirane, decyloxirane, 2,2- and 2,3-dimethyloxiranes, 2,2- and 2,3-diethyloxiranes, 2-methyl-2(3)-ethyloxiranes, 2methyl-2(3)-propyloxiranes, 2-ethyl-3-propyloxirane, 2,2-di-t-butyloxirane, 2,2-bis(2,2-dimethylpropyl)oxirane, 2-methyl-2(3)-pentyloxiranes, 2-(2,2-dimethylpropyl)-2-methyloxirane, 2-methyl-3-phenyloxirane, 2,2,3-trimethyloxirane, 2,2-dimethyl-3-ethyloxirane, 2,2-dimethyl-3-propyloxirane, 2,2,3,3-tetramethyloxirane, trimethylene oxirane, tetramethylene oxirane, oxetane, 2- and 3-methyloxetanes, 2-ethyloxetane, 2-propyoxetane, 2,2-, 2,3-, 2,4-, and 3,3-dimethyloxetanes, 3,3-diethyloxetane, 3,3-dipropyloxetane, 3,3-dibutyloxetane, 3-methyl-3-ethyloxetane, 3-methyl-3-propyloxetane, 3-methyl-3-butyloxetane, 3-methyl-3-pentyloxetane, 3-methyl-3-hexyloxetane, 3-methyl-3-dodecyloxetane, 3-ethyl-3-stearyloxetane, 3-methyl-3-methoxymethyloxetane, 3,3-tetramethylene oxetane, 3,3-pentamethylene oxetane, 2,6-dioxaspiro-(3,3)-heptane, 7-oxabicyclo-(2,2,1)-heptane, oxolane, 2- and 3-methyloxolanes (i.e., 2- and 3-methyltetrahydrofurans, respectively), 2- and 3-ethyloxolanes, 3-isopropyloxolane, 2-isobutyloxolane, 2,2-, 2,3-, 2,4-, 2,5-, 3,3-, and 3,4-dimethyloxolanes, 2-methyl-2-ethyloxolane, oxane, oxocane, oxonane, oxecane, oxepane, 2-, 3-, and 4-methyloxepanes, 3,3-dimethyldioxirane, tetramethyldioxetane, 3-methyl-1,2,4-trioxolane, 2- and 4-methyl-11,3-dioxolanes, 3,5-dimethyl-1,2,4-trioxolane, 2,2-dimethyl-1,3-dioxolane, 3-ethyl-1,2-dioxolane, 3-pentyl-1,2,4-trioxolane, 2-hexyl-1,3-dioxolane, 2-heptyl-1,3-dioxolane, 2-octyl-1,3-dioxolane, 2-hexyl-2,4-dimethyl-11,3-dioxolane, 4,5-dimethyl-2-hexyl-1,3-dioxolane, 2-(4,5-dimethyl-2-hexyl)-1,3-dioxolane, 4,5-dimethyl-2-heptyl-1,3-dioxolane, 4,5-dimethyl-2-(1-ethylpentyl)-1,3-dioxolane, 2,2-diisobutyl-4-methyl-1,3-dioxolane, 4,5-dimethyl-2-octyl-1,3-dioxolane, 2-, 4-, and 5-methyl-1,3-dioxanes, 1,3-dioxepane, 2-methyl-1,3-dioxepane, 2-butyl-1,3-dioxepane, 2-hexyl-1,3dioxepane, 2-heptyl-1,3-dioxepane, 2-octyl-1,3-dioxepane, 2-ethylpentyl-1,3-dioxepane.

Non-limiting examples of halogen-containing chiral and achiral cyclic ethers include epifluorohydrin, epichlorohydrin, epibromohydrin, epiiodohydrin, 2,3-difluorooxirane, trifluorooxirane, tetrafluorooxirane, tetrachlorooxirane, trifluoromethyloxirane, 2-trifluoromethyl-2-methyloxirane, trichloromethyloxirane, 2-trichloromethyl-2-methyl-3-bromooxirane, perfluoromethyloxirane, perchloromethyloxirane, perbromomethyloxirane, 2-methyl-2-chloromethyloxirane, 2-(2,2,2-trifluoroethyl)-3-trifluoromethyloxirane, 2-1H,1H-perfluoroethyloxirane, 2-1H,1H-perchloroethyloxirane, 2-1H,1H-perbromoethyloxirane, 2-1H,1H-perfluoropropyloxirane, 2-1H,1H-perchloropropyloxirane, 2-1H,1H-perbromopropyloxirane, 2-1H,1H-perfluoro(2-methoxy)propyloxirane, 2-1H,1H-perfluoro(2-propoxy)propyloxirane, 2-1H,1H-perfluorobutyloxirane, 2-1H,1H-perfluoroisobutyloxirane, 2-perfluorobutyloxirane, 2-1H,1H-perfluoropentyloxirane, 2-1H,1H-perfluorohexyloxirane, 2-perfluorohexyloxirane, 2-1H,1H-perfluoroisohexyloxirane, 2-1H,1H-perfluoroheptyloxirane, 2-1H,1H-perfluorooctyloxirane, 2-1H,1H-perfluoroisooctyloxirane, 2-1H,1H-perfluorononyloxirane, 2-1H,1H-perfluorodecyloxirane, 2-1H,1H-perfluoroisodecyloxirane, 2-1H,1H-perfluoroundecyloxirane, 2-1H,1H-perfluorododecyloxirane, 2-1H,1H-perfluoroisododecyloxirane, 2-benzyl-2-fluorooxirane, 2-butyl-2-chloromethyloxirane, 2-(3,5-dichlorophenyl)-2-(2,2,2-trichloroethyl) oxirane, 2-(7-fluoro-8-iodooctyl)oxirane, 3,3-difluorooxetane, 2- and 3-methyl-3-chloromethyloxetanes, 2- and 3-ethyl-3-chloromethyloxetanes, 2- and 3-butyl-3-chloromethyloxetanes, 2- and 3-dodecyl-3-chloromethyloxetanes, 2- and 3-stearyl-3-chloromethyloxetanes, 2- and 3-methyl-3-bromomethyloxetanes, 2- and 3-ethyl-3-bromomethyloxetanes, 2- and 3-propyl-3-bromomethyloxetanes, 2- and 3-dodecyl-3-bromomethyloxetanes, 3,3-bis(fluoromethyl)oxetane, 3,3-bis(chloromethyl)oxetane, 3,3-bis(bromomethyl)oxetane, 3,3-bis(iodomethyl)oxetane, 3,3′-perfluorodimethyloxetane, 2-perfluoroethyloxolane, 3-bromooxolane, 2-bromomethyloxolane, difluorodioxirane, 2,3-dichloro-1,4-dioxane, 2-chloromethyl-1,3-dioxolane, 2-chloromethyl-2-fluoromethyl-1,3-dioxolane, hexafluoro-1,2-dioxolane, 3-fluoro-1,2,4-trioxolane, 3-heptadecafluorooctyl-1,2,4-trioxolane, 3,3- and 3,5-difluoro-1,2,4-trioxolanes, and those disclosed in parent U.S. application Ser. No. 11/072,588.

Other suitable cyclic ethers include ethers, esters, urethanes, and ureas of hydroxyl- and/or amine-substituted cyclic ethers, such as hydroxyl oxetanes and aminooxetanes, (e.g., 3-methyl-3-hydroxymethyloxetane, 3-ethyl-3-hydroxymethyloxetane, 3-amyl-3-hydroxymethyloxetane, 3,3-bis(hydroxymethyl)oxetane). Non-limiting examples of such cyclic ethers include 3,3-bis(butoxymethyl)oxetane, 3-ethyl-3-methoxymethyloxetane, 3-ethyl-3-butoxymethyloxetane, 3-ethyl-3-dodecyloxymethyloxetane, 3-ethyl-3-acetoxymethyloxetane, 3-ethyl-3-stearoyloxymethyloxetane, 3-methyl-3-phenoxymethyloxetane, 3-ethyl-3-phenoxymethyloxetane, 3-ethyl-3-N-methyl-carbamoyl methyloxetane, 3-ethyl-3-N-chloroethyl-carbamoylmethyloxetane, 3-ethyl-3-N-phenylcarbamoylmethyloxetane, 3-ethyl-3-N-dichlorophenylcarbamoylmethyloxetane, 3-ethyl-3-N-stearylcarbamoylmethyloxetane, 3,3-bis(phenoxymethyl)oxetane, 3,3-bis(4-chlorophenoxymethyl)oxetane, 3,3-bis(2,4-dichlorophenoxymethyl)oxetane, 3,3-bis(carbamoylmethyl)oxetane, 3-phenoxymethyl-3-carbamoylmethyloxetane.

In one example, the polyether polyahl is formed from at least three different diols and/or cyclic ethers: a first achiral diol or achiral cyclic ether (e.g., HO(CH₂)₄OH, oxolane) in a molar fraction of M₁, a second achiral diol or achiral cyclic ether (e.g., HO(CH₂)₂OH, oxirane) in a molar fraction of M₂, and a chiral diol or chiral cyclic ether (e.g., HOCH(CH₃)(CH₂)₃OH, HOCH₂CH(CH₃)(CH₂)₂OH), HOCH(C₂H₅)(CH₂)₃OH, HOCH₂CH(C₂H₅)(CH₂)₂OH, 2- and 3-methyloxolanes, 2- and 3-ethyloxolanes) or a third achiral diol or achiral cyclic ether (e.g., HO(CH₂)₅₋₉OH, oxetane, oxane, oxepane, oxocane, oxonane, oxecane) in a molar fraction of M₃, with M₁+M₂+M₃≦1. M₂ is a number of at least 0.005, typically 0.01 to 0.6, preferably 0.01 to 0.3, more preferably 0.03 to 0.5, most preferably 0.08 to 0.25. M₃ is a number of at least 0.005, typically 0.01 to 0.8, preferably 0.01 to 0.5, more preferably 0.01 to 0.2, further preferably 0.05 to 0.25, most preferably 0.05 to 0.15. M₁ is number of 0.01 or greater, preferably is 0.15 or greater, but not more than 0.9, more preferably 0.2 to 0.8, most preferably 0.25 to 0.5. M₁=1−M₂−M₃ or, when one or more additional diols and/or cyclic ethers other than the three above are used together to form the polyether polyahl, M₁=1−M₂−M₃. Typically, M₁≧M₃≧M₂, but M₁ may be less than M₃, M₁ may be less than M₂, and M₃ may be less than M₂.

The diols may co-polymerize via condensation, or co-polymerize with cyclic ethers through a base-catalyzed ring-opening reaction. The cyclic ethers may co-polymerize via an acid-catalyzed ring-opening reaction. The different diols and cyclic ethers each have 2 to about 20 carbon atoms, preferably 2 to about 12 carbon atoms, more preferably 3 to about 6 carbon atoms. The resulting polyether polyahl of the polymerization reaction is a random, block, or grafted telechelic copolymer. One of ordinary skill in the art would understand that any chiral diol and its corresponding chiral cyclic ether may be converted from one to the other using conventional chemistry. Conversion of the diols to the cyclic ethers may be particularly desirable to enable subsequent ring-opening polymerization of the cyclic ethers. The catalytic cyclization of diols into cyclic ethers is well known to the skilled in the art.

The polyether polyol can be formed from a first chiral diol or chiral ether and a second diol or cyclic ether at a molar ratio of about 85:15 to about 20:80. The synthesis of polyether polyols from chiral cyclic ethers and achiral cyclic ethers is disclosed in U.S. Pat. Nos. 3,358,042, 4,120,850, 4,568,775, 4,590,285, 4,960,849, and U.S. Patent Application Publication No. 2003/0166821, the disclosures of which are incorporated herein by reference in their entirety.

The polyol as described above may be converted into a polyamine, i.e., replacing the terminal hydroxy groups with amine groups, through an amination reaction as understood by the skilled in the art. The resulting polyamine may then be reacted with an isocyanate to form a polyurea prepolymer, suitable for a polyurea composition in golf ball applications.

The polyahls of the present invention, including the polyols and the polyamines derived therefrom as described above, may further comprise substituted groups or moieties. Suitable substitution groups or moieties include, without limitation, fluoride, chloride, bromide, iodide, cyanide, sulfide, silicone, carboxylate, sulfonate, phosphonate, acrylate, methacrylate, epoxy, hydrocarbon, fluorocarbon, halogenated polyether, polyalkylene oxide, aromatic, or vinyl groups or moieties; urethane or urea units; terminal or pendant functional groups or moieties, such as primary or secondary hydroxyl groups, primary or secondary amine groups, isocyanate groups, (meth)acrylate groups, epoxy groups, neutralized or un-neutralized acid groups, or ethylenically unsaturated polymerizable groups. These units, groups, moieties, or combinations thereof may be present in the polyahls to provide enhanced functionality and/or reactivity.

The unique structural and compositional characteristics of the polyahls results in their physical, chemical, thermal, and other properties that are desirable and advantageous in golf ball applications. For example, these polyahls have lowered crystallinity, lowered melting points, liquid property at a widened range of temperature, improved flexibility at low temperatures, reduced energy loss in tensile mode, improved flex fatigue, improved resilience, and other enhanced elastic properties. The polyahls of the present invention preferably has at least one of material hardness, flexural modulus, elastic modulus, storage modulus, elongation, tensile strength, tear strength, and compression that fluctuates less than about 10% in a temperature range of about −20° C. to about 20° C., more preferably about −25° C. to about 50° C., and most preferably about −30° C. to about 100° C. Suitable polyahls preferably have a molecular weight of about 200 or greater, a polydispersity of about 3 or less, a melting point of about 20° C. or less, a flash point of about 250° C. or greater, a viscosity of about 50 cps to about 20,000 cps at 40° C. Compositions comprising one or more of such polyahls preferably have a density of about 0.8 g/cm³ to about 1.2 g/cm³, a material hardness of about 90 Shore D or less, a percent rebound of about 40% or greater, a hysteresis of about 50% or less, a flexural or elastic modulus of about 500 psi or greater, a water vapor transmission rate of about 2 g/(m²×day) or less. The molecular weight of the preferred polyahls is preferably about 500 to about 10,000, more preferably about 1,000 to about 5,000. The melting point of the preferred polyahls is preferably about 15° C. or less, more preferably about 10° C. or less, further preferably about 5° C. or less, most preferably about 0° C. or less. As understood to one skilled in the art, melting point of an organic material such as the polyahls of the present invention is also referred to as freezing point. The polydispersity of the preferred polyahls is preferably less than about 2.5, and more preferably less than about 2.1, further preferably about 2 or less, most preferably about 1.8 or less. The polyahls further have a hydroxyl number or amine number of about 10 to about 300, preferably about 20 to about 150.

The polyahl of the present disclosure, alone or in a blend of two or more thereof, may be reacted with an isocyanate at an equivalent ratio of about 0.01:1 to about 1:1 to form a polyurethane prepolymer or polyurea prepolymer having a NCO content of about 30% or less, preferably about 15% or less. Any isocyanate available to one of ordinary skill in the art is suitable for use according to the invention. The isocyanate may be organic, modified organic, saturated, aliphatic, alicyclic, unsaturated, araliphatic, aromatic, substituted, or unsubstituted diisocyanate or polyisocyanate monomers having two or more free reactive isocyanate (“NCO”) groups; isomers thereof; modified derivatives thereof; dimers thereof; trimers thereof; biurets thereof, uretdiones thereof, or isocyanurates thereof. The isocyanate may also include any isocyanate-terminated multimeric adducts, oligomers, polymers, prepolymers, low-free-monomer prepolymers, quasi-prepolymers, and modified polyisocyanates derived from the isocyanates and polyisocyanates above. Low-free-monomer prepolymers refer to prepolymers having free isocyanate monomer levels about 0.5 weight percent or less.

In addition to the free reactive isocyanate groups, the suitable isocyanate further comprises at least one cyclic, aromatic, aliphatic, linear, branched, or substituted hydrocarbon moiety R containing from 1 to about 20 carbon atoms, such as arylenes, aralkylenes, alkylenes, or cycloalkylenes. When multiple cyclic or aromatic groups are present, linear, branched or substituted hydrocarbons containing from 1 to about 10 carbon atoms can be present as spacers between such cyclic or aromatic groups. In some cases, the cyclic or aromatic group(s) may be substituted at the 2-(ortho-), 3-(meta-), and/or 4-(para-) positions. Substituted groups may include, but are not limited to, halogens, cyano groups, amine groups, silyl groups, hydroxyl groups, acid groups, alkoxy groups, primary or secondary or tertiary hydrocarbon groups, or a combination of two or more groups thereof. Non-limiting examples of suitable isocyanates include those disclosed in the parent applications, and those disclosed in the co-owned and co-pending U.S. Patent Application Publication No. 2005/0004325 (bearing Ser. No. 10/859,537), the entire disclosure of which is incorporated herein by reference. Any and all of the isocyanates disclosed herein may be used alone or in combination of two or more thereof. Saturated isocyanates display satisfactory light stability when used in golf balls cover layers, and are most preferred in golf ball outer cover layer or coating compositions.

It is well understood in the art that material hardness of polyureas, polyurethanes, and polyurethane/polyurea hybrids may be modified by adjusting the percent NCO content in the isocyanate-terminated prepolymer. Conventionally, the isocyanate-terminated prepolymer has less than about 30% NCO, preferably no greater than about 15% NCO. A percent NCO of about 4% to about 9% may provide a relatively soft elastomer (polyurethane, polyurea, or hybrid thereof) preferably suitable for use in golf ball covers or outer cover layers. A percent NCO of about 7% to about 15% may provide a relatively hard elastomer preferably suitable for use in golf ball intermediate layers, outer core layer, and/or inner cover layers.

The above-described polyahls, present by about 1 weight percent to about 100 weight percent in a blend, may be blended with one or more polyahls known to one of ordinary skill in the art to form the polyurethane prepolymers or polyurea prepolymers. Suitable polyahls for the blend may be organic, modified organic, saturated, aliphatic, alicyclic, unsaturated, araliphatic, aromatic, substituted, or unsubstituted. The polyahl preferably has two or more reactive hydrogen groups per molecule, such as primary or secondary hydroxy groups or amine groups, and at least one cyclic, aromatic, aliphatic, linear, branched, or substituted hydrocarbon moiety containing from 1 to about 20 carbon atoms, such as arylenes, aralkylenes, alkylenes, or cycloalkylenes. When multiple cyclic or aromatic groups are present, linear, branched or substituted hydrocarbons containing from 1 to about 10 carbon atoms can be present as spacers between such cyclic or aromatic groups. In some cases, the cyclic or aromatic group(s) may be substituted at the 2-(ortho-), 3-(meta-), and/or 4-(para-) positions. Substituted groups may include, but are not limited to, halogens, cyano groups, amine groups, silyl groups, hydroxyl groups, acid groups, alkoxy groups, primary or secondary or tertiary hydrocarbon groups, or a combination of two or more groups thereof. The isocyanate-reactive hydroxy and/or amine groups may be terminal or pendant groups on the oligomeric or polymeric backbone, and in the case of secondary amine groups, may even be embedded within the backbone. Non-limiting examples of polyahls suitable for use in the blend include those disclosed in the parent applications and references that are cited and incorporated by reference herein. They may be used alone or in combination of two or more thereof. Saturated polyahls (aliphatic, alicyclic, or fully hydrogenated) are preferred for use as curatives in the present invention, because they afford superior light stability when incorporated into the golf ball cover composition.

Polyahls disclosed in the parent applications and references that are cited and incorporated by reference herein, particularly those having a molecular weight of about 5,000 or less, may be used as curing agents for chain-extension and/or crosslink in a polyurethane or polyurea composition. In particular, the curing agents react with polyurethane prepolymers or polyurea prepolymers, including the ones discussed above, to afford the desired golf ball compositions. Other suitable curing agents for the invention include polyahls and epoxies, preferably hydroxy curatives, amine curatives, and amino alcohol curatives. For best light stability, all reactants in the polyurethane or polyurea compositions are preferably saturated, including the curing agents, the polyahls, and the isocyanates.

As described above, the polyether polyahls formed from diols and/or chiral ethers may be incorporated into a prepolymer, used as a curing agent, or both, in the elastomeric reaction product that forms the golf ball layer. In particular, the polyahls are incorporated into one or more soft segments of the reaction product, and are substantially absent in any hard segments of the reaction product. To form the prepolymer, the polyahl, alone or in a blend with other polyahls disclosed herein, may react with one or more isocyanates at an equivalent ratio of about 0.1:1 to about 0.95:1. When the polyether polyahl is used alone, the equivalent ratio is preferably about 0.3:1 to about 0.6:1, more preferably about 0.5:1. The weight ratio of the polyether polyahl to any other polyahl(s) in a blend may be about 1:20 to about 20:1. The polyahl used in the prepolymer may have a molecular weight of about 500 to about 10,000, preferably from about 1,000 to about 5,000. The resulting prepolymer may be a polyurethane prepolymer, a polyurea prepolymer, or a polyurethane/polyurea prepolymer. The curing agents, used alone or in combination of two or more thereof, may then be used to cure the prepolymer into a thermoplastic or thermoset polyurethane, polyurea, or polyurea/polyurethane hybrid. An equivalent ratio of the prepolymer to the curing agent is preferably about 1:0.6 to about 1:1.5, more preferably about 1:0.8 to about 1:1.2, and most preferably about 1:0.95.

When used as a curing agent, the polyahl may have a molecular weight relative lower than those suitable in the prepolymer, preferably less than about 10,000, more preferably about 200 to about 5,000, and most preferably about 500 to about 3,000. The polyahl curative may be used alone or in combination with other curatives disclosed above. Preferably, the polyahl constitutes at least about 1 weight percent of the total curative mixture, more preferably about 5 weight percent to about 100 weight percent. The polyahl curative alone or in a blend may be used to react with any prepolymers at an equivalent ratio of 0.6:1 to about 1.5 to 1. The prepolymers include those disclosed herein, such as the polyether polyahl-based prepolymers, and any prepolymers formed from any combinations of the polyahls and the isocyanates listed above. Such prepolymers may have only urethane bonds (polyurethane prepolymers), only urea bonds (polyurea prepolymer), or both (polyurethane/polyurea hybrid prepolymer). Preferably, the prepolymer and the reactants therein, the polyahl curative, and any other optional curatives are all saturated.

A variety of additives can optionally be incorporated into the compositions of the present disclosure, or any one or more of the subcomponents thereof. These additives include, but are not limited to, catalysts to alter the reaction rate, fillers to adjust density and/or modulus, processing aids or oils (such as reactive or non-reactive diluents) to affect rheological and/or mixing properties, reinforcing materials, impact modifiers, wetting agents, viscosity modifiers, release agents, internal and/or external plasticizers, compatibilizing agents, coupling agents, dispersing agents, crosslinking agents, defoaming agents, surfactants, lubricants, softening agents, coloring agents including pigments and dyes, optical brighteners, whitening agents, UV absorbers, hindered amine light stabilizers, blowing agents, foaming agents, and any other modifying agents known or available to one of ordinary skill in the art. One or more of these additives may be used in amounts sufficient to achieve their respective purposes and desired effects. Non-limiting examples of such additives and their appropriate amounts are disclosed in the parent applications and in U.S. Patent Application Publication No. 2005/0004325.

Conventional materials used for golf ball covers, intermediate layers, and cores may be blended with the compositions of the present disclosure, by about 1 weight percent to about 95 weight percent of the composition. Non-limiting examples of such materials are disclosed in the parent applications and in U.S. Patent Application Publication No. 2005/0004325. Preferably, a thermoplastic composition of the present disclosure is used, optionally in a blend with one or more conventional thermoplastic materials.

The golf ball cover layer or at least one sub-layer thereof (e.g., inner cover layer, outer cover layer) may preferably be formed from one of the compositions disclosed herein. The cover layer can have a thickness from 0.001 inches to 0.125 inches, preferably from 0.005 inches to 0.1 inches, more preferably from 0.01 inches to 0.05 inches, most preferably from 0.015 inches to 0.04 inches, like 0.035 inches. Alternatively, the thickness of the cover layer is 0.5 inches or less, preferably 0.05 inches to 0.2 inches, more preferably 0.05 inches to 0.1 inches. The cover layer may have a flexural modulus of 1,000 to 100,000 psi, preferably 1,000 psi to 80,000 psi, more preferably 1,000 to 50,000 psi, even preferably 1,000 psi to 30,000 psi, most preferably 2,000 psi to 25,000 psi, alternatively 10,000 psi to 80,000 psi. The Shore D hardness of the cover layer may be 90 or less, preferably 20 to 70, more preferably 20 to 60, further preferably from 25 to 55, even preferably from 30 to 55, most preferably from 40 to 55. The cover layer may preferably have a WVTR of about 2 g/(m²×day) or less,

The core of the golf ball may be solid, fluid-filled, gel-filled, or gas-filled, having a single-piece construction or a multi-piece construction that includes a center and one or more outer core layers. Non-limiting examples of materials and compositions suitable for forming the core or one or more layers of the core are disclosed in the parent applications and in U.S. Patent Application Publication No. 2005/0004325. Preferred compositions for solid cores include a base rubber (e.g., polybutadiene rubbers having a 1,4-cis content of at least about 40%), a crosslinking agent (e.g., ethylenically unsaturated acids having 3 to 8 carbon atoms and metal salts thereof), an initiator (e.g., peroxides, carbon-carbon initiators, and blends of two or more thereof) and, optionally, one or more additives (e.g., CoR enhancer like halogenated organosulfur compounds).

The golf ball core may have a diameter of 0.5 inches or greater, preferably 1 inch or greater, more preferably 1.5 inches or greater, further preferably 1.54 inches or greater, even preferably 1.545 inches or greater, most preferably 1.55 inches or greater, typically about 1.65 or less, or about 1.6 inches or less. The core may have an Atti compression of 20 to 120, preferably 30 to 100, more preferably 40 to 90, further preferably 45 to 85, further preferably 50 to 80, further preferably 50 to 75, even more preferably 50 to 65, most preferably 55 to 60; alternatively, the compression may be 25 or less, or 20 or less. The core may have a CoR of 0.7 or greater, preferably 0.75 or greater, more preferably 0.77 or greater, further preferably 0.79 or greater, even more preferably 0.8 or greater, and most preferably 0.81 or greater. The core may comprise a center and one or more outer core layers. The outer core layer may have a thickness of 0.5 inches or less, preferably 0.3 inches or less, more preferably 0.25 inches to 0.3 inches.

One, two, or more optional intermediate layers may be disposed between the core and the cover. The intermediate layer may be part of the core as an outer core layer, or part of the cover as an inner cover layer. In one example, an intermediate layer can be formed from a hard, high flexural modulus, resilient material which contributes to the low spin, distance characteristics when they are struck for long shots (e.g. driver or long irons). The material of the intermediate layer can have a Shore D hardness of 65-80, preferably 69-74, more preferably 70-72. The flexural modulus of the intermediate layer can be at least 65,000 psi, preferably from 70,000 psi to 120,000 psi, more preferably from 75,000 psi to 100,000 psi. The thickness of the inner cover layer may be from 0.020 inches to 0.045 inches, preferably from 0.030 inches to 0.040 inches. The intermediate layer preferably has a WVTR lower than that of the cover. More preferably, the WVTR of the intermediate layer is no greater than that of an ionomer resin such as Surlyn®, which is in the range of about 0.45 g/(m²×day) to about 0.95 g/(m²×day). Non-limiting examples of suitable materials and compositions that form the intermediate layers are disclosed in the parent applications and in U.S. Patent Application Publication No. 2005/0004325.

The resultant golf balls typically have a CoR of about 0.7 or greater, preferably about 0.75 or greater, more preferably about 0.78 or greater, most preferably about 0.8 or greater. The golf balls also typically have an Atti compression of at least about 40, preferably from about 50 to 120, and more preferably from about 60 to 100. The golf balls typically have dimple coverage greater than about 60 percent, preferably greater than about 65 percent, and more preferably greater than about 75 percent. The diameter of the golf ball is preferably from 1.680 inches to 1.800 inches, more preferably from 1.680 inches to 1.760 inches, most preferably from 1.680 inches to 1.740 inches.

Golf balls of the present invention may have a variety of constructions, typically comprising at least a core and a cover. Optionally, one or more intermediate layers may be disposed between the core and the cover; the core may be a single solid mass, or include a solid, liquid-filled, gel-filled or gas-filled center and one or more outer core layers; and the cover may include an outer cover layer and one or more inner cover layers. Any of the outer core layers, the intermediate layers, or the inner cover layers may be a continuous layer, a discontinuous layer, a wound layer, a molded layer, a lattice network layer, a web or net, an adhesion or coupling layer, a barrier layer, a layer of uniformed or non-uniformed thickness, a layer having a plurality of discrete elements such as islands or protrusions, a solid layer, a metallic layer, a liquid-filled layer, a gas-filled layer, or a foamed layer.

The compositions for golf ball portions as disclosed herein may be used in sporting equipment in general. Specifically, the compositions may be applied in various game balls, golf club shafts, golf club head inserts, golf shoe components, and the like.

All patents and patent applications cited in the foregoing text are expressly incorporated herein by reference in their entirety.

The invention described and claimed herein is not to be limited in scope by the specific embodiments herein disclosed, since these embodiments are intended solely as illustrations of several aspects of the invention. Any equivalent embodiments and various modifications apparent to those skilled in the art are intended to be within the scope of this invention. It is further understood that the various features of the present invention can be used singly or in combination thereof. Such modifications and combinations are also intended to fall within the scope of the appended claims.

What is claimed is:

1. A golf ball comprising:
a core, the core having a diameter of 1 inch or greater;
a cover layer disposed about the core, the cover layer having a thickness of 0.005 inches to 0.1 inches and being formed from a composition comprising a polyether polyahl, wherein the polyether polyahl comprising —O(CH₂)₄—, —O(CH₂)₂—, and a branched oxyalkylene monomer unit; and
an optional intermediate layer disposed between the core and the cover layer.

2. The golf ball of claim 1, wherein the core is a solid core having a compression of 40 to 100 or a coefficient of restitution of 0.7 or greater, and the cover layer has a flexural modulus of 1,000 psi to 100,000 psi or a Shore D hardness of 90 or less.

3. The golf ball of claim 1, wherein the golf ball has a coefficient of restitution of 0.7 or greater.

4. The golf ball of claim 1, wherein the branched oxyalkylene monomer unit has a structure of: 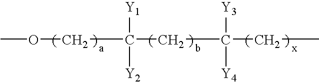
where Y₁ to Y₄ are independently hydrogen or hydrocarbon moieties, at least one of which is an alkyl moiety having 1 to about 10 carbon atoms; and a, b, and x are independently zero or integers from 1 to about 10.

5. The golf ball of claim 4, wherein the branched oxyalkylene monomer unit is —OCH₂CH(CH₃)(CH₂)₂—, —OCH(CH₃)(CH₂)₃—, —OCH(CH₃)(CH₂)₂—, —OCH₂CH(CH₃)CH₂—, —OC(CH₃)₂CH₂—, —OCH(C₂H₅)CH₂—, or —OCH(CH₃)CH₂—.

6. The golf ball of claim 1, wherein the polyether polyahl is formed from oxolane having a molar fraction M₁ of 0.01 to 0.9, oxirane having a molar fraction M₂ of 0.005 to 0.6, and a chiral cyclic ether having a molar fraction M₃ of 0.005 to 0.8, M₁+M₂+M₃≦1.

7. The golf ball of claim 1, wherein the polyether polyahl has a random or block copolyether backbone and primary or secondary hydroxyl or amine end groups, and is an α,β-dihydroxytelechelic copolyether, an α,β-diaminotelechelic copolyether, or an α-amino-β-hydroxytelechelic copolyether.

8. The golf ball of claim 1, wherein the composition is an addition reaction product of the polyether polyahl, an isocyanate, and, optionally, one or more polyahls reactive to the isocyanate.

9. The golf ball of claim 8, wherein the addition reaction product is a polyurethane or polyurea having a soft segment formed from the polyether polyahl.

10. The golf ball of claim 1, wherein the polyether polyahl is substantially saturated.

11. A golf ball comprising:
a core; and
a layer disposed about the core, the layer being formed from a composition comprising a polyether polyahl, wherein the polyether polyahl comprises three or more different oxyalkylene monomer units that are independently substituted or unsubstituted.

12. The golf ball of claim 11, wherein the core has a diameter of 1 inches or greater, a compression of 40 to 100, and a first coefficient of restitution of 0.7 or greater, the layer has a thickness of 0.001 inches to 0.125 inches, a flexural modulus of 1,000 psi to 100,000 psi, and a Shore D hardness of 90 or less.

13. The golf ball of claim 11, wherein the golf ball further comprises a cover layer disposed about the layer.

14. The golf ball of claim 11, wherein the polyether polyahl is free of unsaturated aliphatic hydrocarbon radicals and aromatic hydrocarbon radicals.

15. The golf ball of claim 11, wherein the polyether polyahl has a random or block copolyether backbone, and a structure of Z₁-(OR₇)ᵣ—(OR₈)ₛ—(OR₉)ₜ-Z₂, where R₇, R₈, and R₉ are different divalent radicals chosen from unsubstituted and substituted C₂₋₂₀ linear or branched alkylenes; Z₁ and Z₂ are the same or different monovalent radicals each comprising one or more active hydrogen moieties; r, s, and t are independent numbers each being 0.005 to 0.99, and r+s+t=1.

16. The golf ball of claim 15, wherein each of Z₁ and Z₂ independently comprises a primary hydroxyl group or a primary or secondary amine group.

17. The golf ball of claim 15, wherein R₇ is —(CH₂)₄—, R₈ is —(CH₂)₂—, and R₉ is —CH(CH₃)(CH₂)₃—, —CH₂CH(CH₃)CH₂CH₂—, —CH(C₂H₅)(CH₂)₃—, —CH₂CH(C₂H₅)CH₂CH₂—, —(CH₂)₃—, —(CH₂)₅—, —(CH₂)₆—, —(CH₂)₇—, —(CH₂)₈—, or —(CH₂)₉—.

18. The golf ball of claim 11, wherein the polyether polyahl is formed from three or more different cyclic ethers, at least one of which is chosen from halogen-substituted cyclic ethers, and ethers, esters, urethanes, or ureas of hydroxyl- or amine-substituted cyclic ethers.

19. The golf ball of claim 11, wherein the layer is a cover layer, and the golf ball further comprises an intermediate layer disposed between the core and the cover layer.
